(19) United States
(12) Patent Application Publication
(10) Pub. No.: US 2020/0147558 A1
(43) Pub. Date: May 14, 2020

(54) Graphene Oxide Coated Porous Hollow Fibrous Substrates for Carbon Dioxide Capture

(71) Applicants: MIAO YU, PITTSFORD, NY (US); FANGLEI ZHOU, WEST COLUMBIA, SC (US); NGOC TIEN HUYNH, COLUMBIA, SC (US); SHIGUANG LI, MOUNT PROSPECT, IL (US)

(72) Inventors: MIAO YU, PITTSFORD, NY (US); FANGLEI ZHOU, WEST COLUMBIA, SC (US); NGOC TIEN HUYNH, COLUMBIA, SC (US); SHIGUANG LI, MOUNT PROSPECT, IL (US)

(21) Appl. No.: 16/494,955

(22) PCT Filed: Mar. 29, 2018
(86) PCT No.: PCT/US2018/025039

§ 371 Date: Sep. 17, 2019

Related U.S. Application Data
(60) Provisional application No. 62/478,222, filed on Mar. 29, 2017.
(60) Provisional application No. 62/536,070, filed on Jul. 24, 2017.

(51) Int. Cl. B01D 69/08; B01D 69/02; B01D 67/00; B01D 69/12; B01D 71/52; B01D 71/64; B01D 71/68; B01D 71/02

(52) U.S. Cl. CPC B01D 69/08; B01D 69/02; B01D 67/0088; B01D 69/12; B01D 2053/224; B01D 71/64; B01D 71/68; B01D 71/021; B01D 71/52

(57) ABSTRACT

A membrane for the capture of carbon dioxide is provided. The membrane includes a polymeric porous hollow fiber substrate and a coating disposed on a surface of the polymeric porous hollow fiber substrate, where the coating comprises graphene oxide and an amine. A method of forming a coated polymeric hollow fiber support for the capture of carbon dioxide is also provided. The method includes dispersing graphene oxide in a coating solution comprising a solvent; dispersing an amine in the coating solution; and exposing a polymeric hollow fiber support to the coating solution to form a coating on a surface of the polymeric hollow fiber support, wherein the coated polymeric hollow fiber support has a carbon dioxide/nitrogen selectivity ranging from about 200 to about 2000 and a carbon dioxide permeance ranging from about 100 gas permeation units to about 1000 gas permeation units.

### CROSS-REFERENCE TO RELATED APPLICATIONS

The present application claims priority to U.S. Provisional Patent Application Ser. No. 62/478,222, titled “Amine-Enhanced Graphene Oxide (GO) Membranes for CO₂ Separation,” filed on Mar. 29, 2017; and U.S. Provisional Patent Application Ser. No. 62/536,070, titled “Graphene Oxide Coated Porous Hollow Fibrous Substrates for Carbon Dioxide Capture,” filed on Jul. 24, 2017, the disclosures of which are incorporated by reference herein.

### STATEMENT AS TO RIGHTS TO INVENTIONS MADE UNDER FEDERALLY SPONSORED RESEARCH

This invention was made with Government support under Contract No. DE-FE0026383, awarded by the United States Department of Energy. The Government has certain rights in the invention.

### FIELD OF INVENTION

The present invention is generally directed to methods of forming ultrathin, graphene-based coatings on porous hollow fibers for use in carbon dioxide capture.

### BACKGROUND

Currently, amine absorption is the benchmark for the capture of carbon dioxide from power plant flue gases. However, studies show that using such a chemical absorption with an aqueous monoethanolamine system to capture 90% of the carbon dioxide from flue gas will require an increase in the levelized cost of energy (LCOE) services of about 75% to 85%. Such values are well above the 2020 Department of Energy (DOE) National Energy Technology Laboratory (NETL) Sequestration Program post-combustion capture goal of 90% capture in existing plants with less than a 35% increase in LCOE. As such, the development of new advanced carbon dioxide capture technologies in order to maintain the cost-effectiveness of coal-fired power generation in the United States is important.

One such carbon dioxide capture technology involves the use of membranes. Compared with amine absorption, membrane processes require less energy to operate and do not require chemicals or regenerating absorbents to maintain. In addition, membranes are compact and can be retrofitted onto the tail end of power-plant flue gas streams without complicated integration. Recent systems analysis and feasibility studies show that membranes are a technically feasible and economically viable option for CO₂ capture from the flue gas exhaust from coal-fired power generation. The two basic criteria for determining whether a membrane can be effectively utilized for flue gas applications are permeance and selectivity in the desired operating environment. Currently, the only commercially viable membranes for CO₂ removal are polymer based, such as polysiloxanes, cellulose acetate, polyimides, polyamides, polysulfone, polycarbonates, and polyetherimide. The most widely used and tested of these membrane materials is cellulose acetate. However, these commercially available polymer membranes for CO₂ removal typically have a permeance of only about 100 gas permeation units (GPU), which is too low for flue gas CO₂ capture, and a CO₂/N₂ selectivity of about 30.

One group, Membrane Technology and Research, has developed a polymeric, spiral wound gas separation membrane that can exhibit a pure-gas CO₂ permeance of about 1,650 GPU at 50° C. with an ideal selectivity (ratio of single gas permeances) of about 50 for CO₂/N₂. The main limitations of a process utilizing such a membrane are (1) the low mixture CO₂/N₂ selectivity, which is about 20-30, (2) the requirement of compression, permeate side sweep, application of a permeate side vacuum, or a combination of these features in order to provide the separation driving force, and (3) an increase in COE of 57%.

Another group at Ohio State University has prepared a zeolite/polymer composite membrane containing an amine cover layer for CO₂ capture. Scaled membranes show a selectivity of 140 for CO₂/N₂ mixtures. However, the projected increase in COE is between 48.7% and 58.7%. Further, because the membranes contain high alumina zeolite Y, membrane performance and stability at high humidity levels and issues related to flue gas contaminants such as SO₂ and NOₓ must be overcome. As such, while it has been proven to be challenging to achieve the performance and cost goals set forth above by using a singular, standard gas treatment system (e.g., those based on solvents, sorbents, or membranes alone), the development of a hybrid separation system attain these goals.

Thus, there is a need for new membranes for flue gas CO₂ capture that has improved permeation and selectivity and that does not rely solely on chemical absorption processes, solvents, etc. Specifically, a need exists for a low-cost gas separation membrane that can be used for separating and capturing carbon dioxide from coal-fired power plants. In particular, a membrane that can be installed in new or retrofitted pulverized coal power plants to separate and capture at least 90% of the carbon dioxide with 95% carbon dioxide purity at a levelized cost of electricity (LCOE) that is 30% less than exiting carbon dioxide capture approaches would be beneficial.

### SUMMARY

Objects and advantages of the invention will be set forth in part in the following description, or may be obvious from the description, or may be learned through practice of the invention.

In one particular embodiment of the present invention, a membrane for the capture of carbon dioxide is provided. The membrane includes a polymeric porous hollow fiber substrate and a coating disposed on a surface of the polymeric porous hollow fiber substrate, where the coating comprises graphene oxide and an amine.

In one embodiment, the polymeric porous hollow fiber substrate can include polyethersulfone, polyetheretherketone, polyetherimide, or a combination thereof.

In another embodiment, the polymeric porous hollow fiber substrate can have a pore size ranging from about 1 nanometer to about 100 nanometers.

In still another embodiment, the coating can have a thickness ranging from about 1 nanometer to about 100 nanometers.

In one more embodiment, the graphene oxide can include graphene oxide quantum dots.

In yet another embodiment, structural defects can be present on the coating.

In an additional embodiment, the amine can include ethylenediamine, piperazine, monoethanolamine, or a combination thereof.

In a further embodiment, the membrane can have a carbon dioxide/nitrogen selectivity ranging from about 200 to about 2000.

In another embodiment, the membrane can have a carbon dioxide permeance ranging from about 100 gas permeation units to about 1000 gas permeation units.

A method of removing carbon dioxide from a mixture of gas is also provided. In particular, the method can include exposing the membrane to the mixture of gas.

In another embodiment of the present invention, a method of forming a coated polymeric hollow fiber support for the capture of carbon dioxide is provided. The method includes dispersing graphene oxide in a coating solution comprising a solvent; dispersing an amine in the coating solution; and exposing a polymeric hollow fiber support to the coating solution to form a coating on a surface of the polymeric hollow fiber support, wherein the coated polymeric hollow fiber support has a carbon dioxide/nitrogen selectivity ranging from about 200 to about 2000 and a carbon dioxide permeance ranging from about 100 gas permeation units to about 1000 gas permeation units.

In one embodiment, the solvent can be water.

In another embodiment, the polymeric hollow fiber substrate can include polyethersulfone, polyetheretherketone, polyetherimide, or a combination thereof.

In still another embodiment, the graphene oxide can include graphene oxide quantum dots.

In one more embodiment, the graphene oxide can be present in the coating solution at a concentration ranging from about 0.001 wt. % to about 1 wt. % based on the total weight of the coating solution.

In yet another embodiment, the amine can include ethylenediamine, piperazine, monoethanolamine, or a combination thereof.

In an additional embodiment, the amine can be present in the coating solution at a concentration ranging from about 0.1 wt. % to about 10 wt. % based on the total weight of the coating solution.

In a further embodiment, the polymeric porous hollow fiber substrate can be exposed to the coating solution under vacuum filtration for a time period ranging from about 10 seconds to about 5 minutes.

In one more embodiment, the method can include forming structural defects in the coating.

In another embodiment, the method can include subjecting the coated polymeric porous hollow fiber substrate to vacuum drying for a time period ranging from about 1 minute to about 1 hour.

In still another embodiment, a membrane that includes graphene oxide and an amine is described. Further, the graphene oxide can include graphene oxide quantum dots, while the amine can include ethylenediamine, piperazine, monoethanolamine, or a combination thereof.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying Figures.

FIG. 1 shows an exemplary chemical structural model of graphene oxide (GO) composed of a graphene sheet derivatized by phenyl epoxide and hydroxyl groups on the basal plan and carboxylic acid groups on the edges.

FIG. 2A shows a schematic diagram of an exemplary system for coating a GO membrane onto a hollow fiber substrate.

FIG. 2B shows a schematic diagram of another exemplary system for coating a GO membrane onto a hollow fiber substrate.

FIG. 3 shows a coil of a hollow fiber substrate before the substrate is coated with a GO membrane.

FIG. 4 is an SEM image of an inner surface of the hollow fiber substrate of FIG. 3.

FIG. 5 is an SEM image of a GO membrane coating deposited on the hollow fiber substrate of FIG. 3.

FIG. 6 is an SEM of a cross-section of the hollow fiber substrate of FIG. 3 after coating the hollow fiber substrate with a GO membrane.

FIG. 7 shows a cross-sectional schematic view of a feed of humidified flue gas that contains water, carbon dioxide, and nitrogen that is separated via carbon dioxide permeation through an exemplary ultrathin GO membrane.

FIG. 8 is a graph comparing the carbon dioxide (CO₂) permeance in gas permeation units (BPU) and CO₂/N₂ selectivity of the GO coated substrates of the present invention with three comparative membranes.

FIGS. 9A, 9B, 9C, and 9D a PES hollow fiber (HF) and its supported GO membrane. Specifically, FIG. 9A is a photo of a blank PES HF; FIG. 9B is an SEM image of the inner surface of the blank PES; FIG. 9C is an SEM image of the inner surface of a GO coated PES HF; and FIG. 9D is a cross-sectional SEM view of a GO coated PES HF.

FIG. 10 shows CO₂ and N₂ adsorption isotherms on GO at 25° C., where the lines are Langmuir model fitting.

### DEFINITIONS

As used herein, the prefix “nano” refers to the nanometer scale (e.g., from about 1 nm to about 100 nm). For example, particles having an average diameter on the nanometer scale (e.g., from about 1 nm to about 100 nm) are referred to as “nanoparticles”.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Generally, the present invention is directed to Amine-enhanced graphene oxide (GO) membranes are generally provided for CO₂ separation, in addition to their methods of formation and use. In one embodiment, the amine-enhanced GO membranes may be utilized for CO₂ capture from flue gas, CO₂ separation from natural gas, CO₂ separation from biogas, etc. Such amine-enhanced GO membranes incorporate amine moieties, which serve as an effective CO₂ carrier, and may greatly enhance CO₂ solubility and transport rate, especially under wet conditions and at elevated temperatures (>40° C.). Thus, the amine-enhanced GO membranes can efficiently separate CO₂ from other inner gas molecules, such as N₂ and CH₄, with high CO₂ permeance and high selectivity of CO₂ over other components. The present invention is also directed to a separation membrane that includes the aforementioned graphene oxide membrane coated onto a polymeric porous hollow fiber substrate. A method of forming the separation membrane by coating graphene oxide onto one or more surfaces of the membrane is also described, as well as a method of separating carbon dioxide from humidified glue gas via use of the separation membrane.

According to one method, the amine-enhanced GO membranes can be prepared by facile solution-based deposition processes, such as vacuum filtration, dip-coating and spray printing etc., on low cost, polymeric porous hollow fiber supports (PES, PS, polyimide, PVDF etc.). The prepared amine-enhanced GO membranes may have significantly enhanced CO₂ permeance and CO₂ selectivity over inner components, such as N₂ and CH₄.

More specifically, in the present invention, graphene oxide (GO) was used as a membrane skeleton in which to incorporate molecules with a strong affinity with CO₂, such as amines (e.g., ethylenediamine, piperazine, monoethanolamine, etc.), for high flux and high selectivity CO₂ capture under humidified flue gas conditions. The GO-based membrane can be prepared by a facile solution-based deposition process on low cost, polymeric porous hollow fiber substrate and tested for CO₂ capture under simulated flue gas conditions. The membrane of the present invention exhibits superior separation performance compared to existing GO membranes and is characterized by a CO₂ permeance higher than 100 GPU and a CO₂/N₂ mixture selectivity higher than 200. For instance, the CO₂ permeance can range from about 100 GPU to about 1000 GPU, such as from about 110 GPU to about 750 GPU, such as from about 125 GPU to about 600 GPU. In addition, the CO₂/N₂ selectivity can range from about 200 to about 2000, such as from about 250 to about 1750, such as from about 300 to about 1600.

In addition, the developed GO membrane fabrication process is scalable and thus has great potential for large scale CO₂ capture from coal-fired power plants. Further, the method of the present invention contemplates the use of GO-based membranes for CO₂ capture under wet/humidified conditions. Considering the low material costs, the facile membrane fabrication process, the superior CO₂ capture performance, and expected excellent membrane stability, this new generation of CO₂ separation membrane holds great potential for CO₂ capture from coal-fired power plants.

The various components of the separation membrane of the present invention, as well as a method of forming the membrane and a method of separating Co₂ from flue gas using the membrane are described in more detail below.

I. Graphene Oxide Coating and Porous Hollow Fiber Substrate Membrane

a. Graphene Oxide Coating

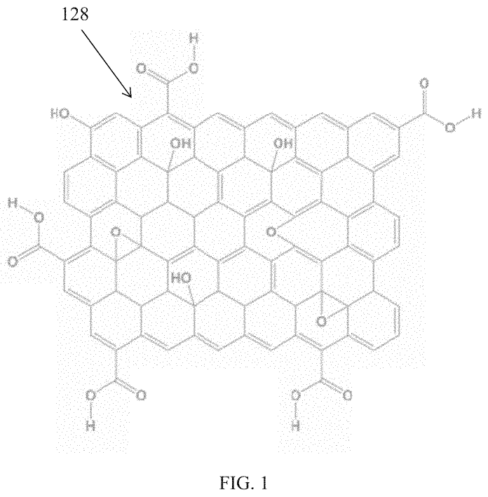

The coating on the separation membrane contemplated by the present invention is formed from graphene oxide (GO). Graphene oxide is an oxidized form of graphene that is made of single layer of carbon atoms bonded in a hexagonal honeycomb lattice. Due to the strong oxidation conditions during its synthesis, a large amount of oxygen-containing groups, including epoxide, hydroxyl, and carboxylic acid groups, exists in GO. Referring to FIG. 1, the chemical structure of graphene oxide composed of a graphene sheet derivatized by phenyl epoxide and hydroxyl groups on the basal plane and carboxylic acid groups on the edge is shown. Such functional groups lead to good hydrophilicity and allow excellent dispersion of GO flakes in water, which greatly facilitates GO deposition from solution using water as a low-cost and environmentally friendly solvent.

In some embodiments, the GO coating 128 can be in the form of flakes or sheets having an average sheet size greater than 100 nanometers (nm). In other embodiments, the graphene oxide can be in the form of graphene oxide quantum dots (GOOD), which have an average sheet or dot size that is less than 100 nm. Regardless, the graphene oxide coating can have a thickness that is less than about 100 nm. For instance, the coating can have a thickness ranging from about 1 nm to about 100 nm, such as from about 5 nm to about 75 nm, such as from about 10 nm to about 50 nm. Further, in some embodiments, the coating can have a thickness that is 20 nm or less. For example, the coating can have a thickness ranging from about 1 nm to about 20 nm.

In one example, the formation of structural defects on the graphene oxide flakes or quantum dots can be utilized to highly selectively separate CO₂ from other components such as N₂. See e.g., U.S. Pat. No. 9,108,158, titled “Ultrathin, Molecular-Sieving Graphene Oxide Membranes for Separations,” which is incorporated by reference herein. In one particular embodiment, structural defects can be formed on the graphene oxide coating by nitric acid (HNO₃) etching via sonication, which creates decreases the lateral size of the GO coating to allow for the passage of increased levels of CO₂ through the coating and hence the membrane.

b. Porous Hollow Fiber Substrate

The porous hollow fiber substrate onto which the GO is coated can be formed from any suitable polymer. In one particular embodiment, the polymer can be polyethersulfone (PES). In other embodiments, the polymer can be polyetheretherketone (PEEK) or polyetherimide (PEI). The porous hollow fiber substrate can have a thickness ranging from about 50 nanometers (nm) to about 90 nm, such as from about 55 nm to about 80 nm, such as from about 60 nm to about 70 nm. Further, the porous hollow fiber substrate can have a pore size ranging from about 10 nm to about 100 nm, such as from about 15 nm to about 75 nm, such as from about 20 nm to about 50 nm.

c. Other Components

In some embodiments, the membrane of the present invention can include one or more amines incorporated into the GO coating to facilitate CO₂ separation. For instance, ethylenediamine (EDA), piperazine (PZ), monoethanolamine (MEA) or a combination thereof can be incorporated into the GO coating solution in amounts ranging from about 0.1 wt. % to about 10 wt. %, such as from about 1 wt. % to about 7.5 wt. %, such as from about 2 wt. % to about 5 wt. % of the total weight of the GO coating solution, where including amines in the coating solution can facilitate an increase in CO₂ permeance, where the absence of amines have low CO₂ permeance due to the low solubility of CO₂ in water.

In other embodiments, more functional groups can be added to the GO coating to facilitate CO₂ separation. For instance, epoxide, hydroxyl, and/or carboxylic acid groups can be added to the GO coating.

II. Method of Coating Graphene Oxide onto the Porous Hollow Fiber Substrate

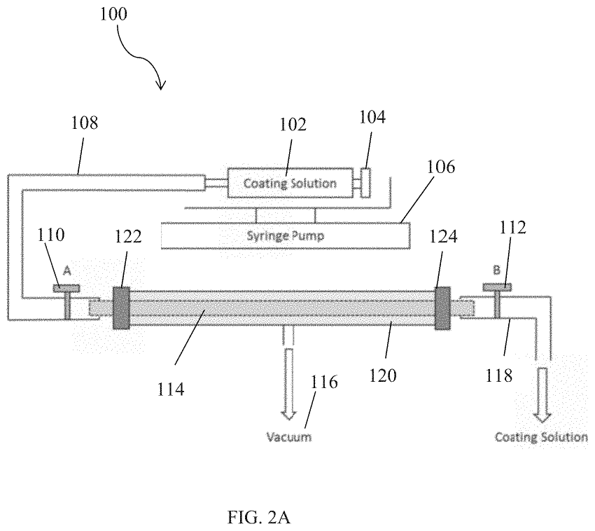

Referring now to FIG. 2, in one embodiment of the present invention, a coating system 100 can be utilized to form a coating of graphene oxide on a porous hollow fiber substrate to form the CO₂ separation membrane of the present invention. In particular, the system 100 includes a syringe 104 that holds a coating solution 102. A syringe pump 106 is used to deliver the coating solution 102 through tubing 108 at a controlled flow rate. When valve 110 and valve 112 are open, the coating solution 102, which contains graphene oxide flakes and can contain any other components such as the amines discussed above, flows continuously in the porous hollow fiber substrate 114 that is contained between sealed ends 122 and 124 of module 120 until the coating solution continuously flows through valve 112 and into tubing 118. Subsequently, vacuum filtration can be conducted under different liquid flow rates on the feed side, where the liquid flow rate ranges from 0 milliliters per minute to about 10 milliliters per minute, such as from about 0 milliliters per minute to about 5 milliliters per minute, such as from about 0 milliliters per minute to about 2 milliliters per minute, for a time period ranging from about 10 seconds to about 5 minutes, such as from about 15 seconds to about 2 minutes, such as from about 30 seconds to about 1 minute. Once the coating process has been carried out for the desired amount of time, valves 122 and 124 can be closed while keeping the permeate side under vacuum via a vacuum pump 116 to dry the now coated porous hollow fiber substrate 114. The drying time can range from about 1 minute to about 1 hour, such as from about 5 minutes to about 45 minutes, such as from about 10 minutes to about 30 minutes. Thereafter, the substrate 114, which is now coated, can then be disconnected from the coating system 100 and used for CO₂ separation.

In addition to the coating system 100 shown in FIG. 2A, it is to be understood that other coating systems and methods are also contemplated by the present invention. For instance, referring to FIG. 2B, one coating method 101 can include inserting a first end 115 of a porous hollow fiber substrate 114 into a coating solution 102 containing a GO dispersion with the desired concentration, and then applying a vacuum 116 on a second end 117 of the porous hollow fiber substrate 114 to pull the coating solution 102 into the lumen 113 of the porous hollow fiber substrate 114. After being filled with the coating solution 102, the porous hollow fiber substrate 114 can be removed from the coating solution 102, while maintaining vacuum on the second end 117. When the coating solution 102 in the hollow fiber substrate 114 is removed, air 121 can be flowed into the lumen 113 to dry the inner surface 126 to form a thin GO coating 128.

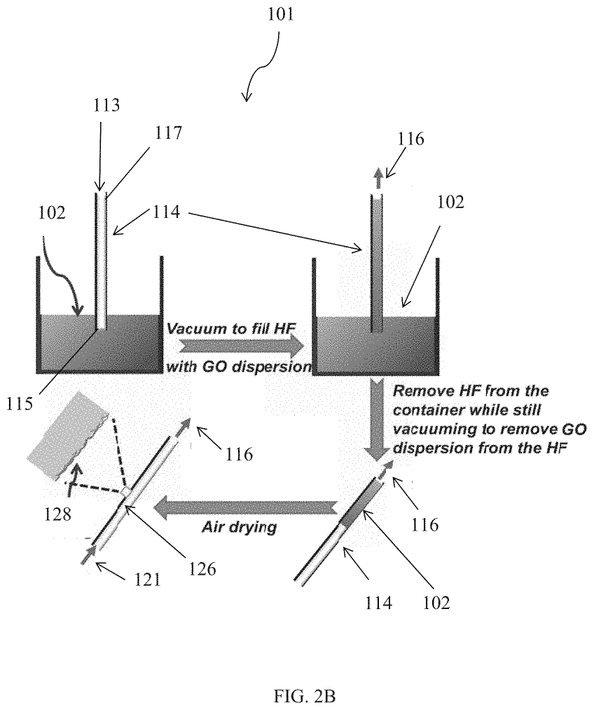

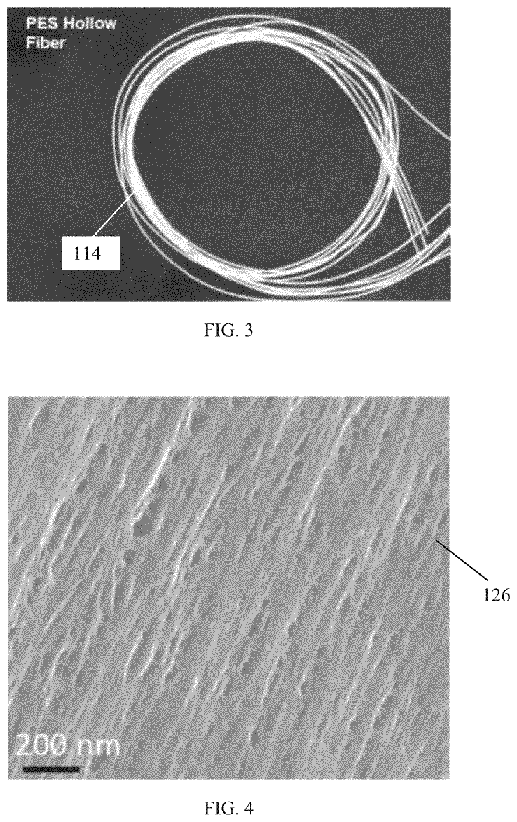

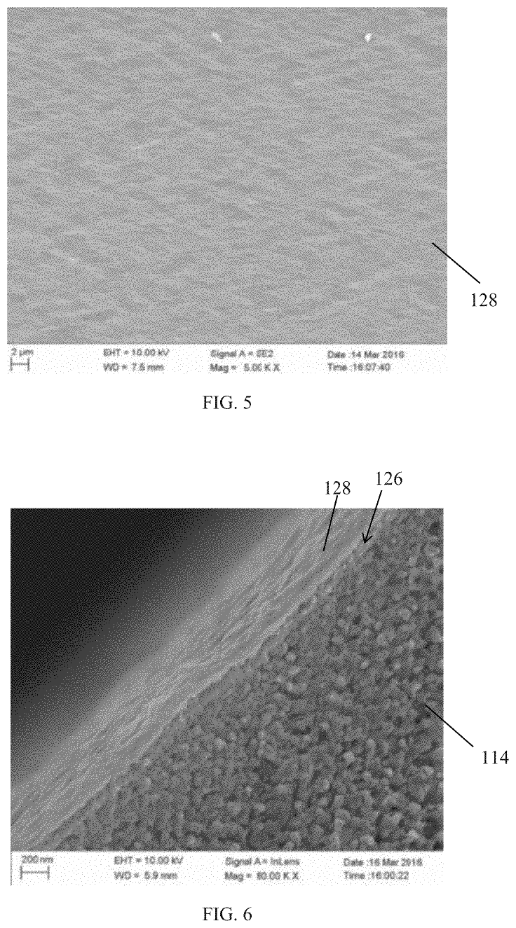

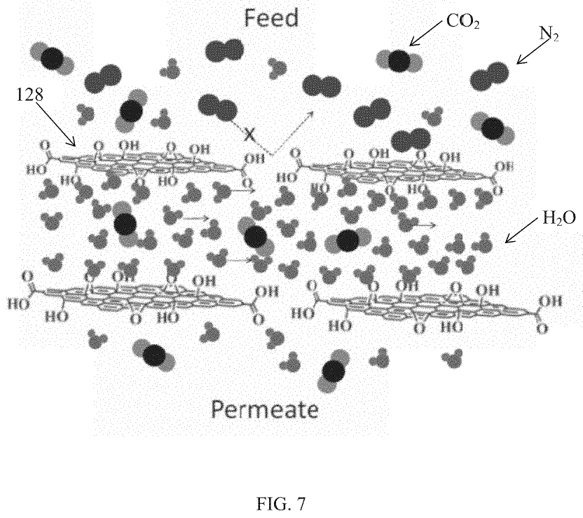

Referring now to FIG. 3, an exemplary porous hollow fiber substrate 114 formed by any of the methods and systems described herein is shown. In addition, FIG. 4 shows an SEM image of a surface 126 of the porous hollow fiber substrate 114 before it is coated with a GO-based coating via coating system 100. The surface 126 is rough and is characterized by long nanofibers and pores having a pore size between about 20 nanometers and about 50 nanometers. Meanwhile, FIG. 5 is an SEM of GO coating 128 on the surface 126 of FIG. 4. As shown, the surface of the GO coating 128 is smooth without any cracks and has a thickness between 10 nm and 15 nm. However, in some embodiments, the GO coating 128 can have a thickness ranging from about 10 nm to about 50 nm, such as from about 20 nm to about 45 nm, such as from about 30 nm to about 40 nm. Referring now to FIG. 6, a cross section of the porous hollow fiber substrate 114 coated with the GO coating 128 on surface 126 is shown.

The GO coating 128's thickness and quality can influence the overall membrane selectivity and gas permeance. Coating parameters that can be varied include GO dispersion concentration, amine concentration, feed flow rate, temperature, etc. The GO concentration in the coating solution can, in some embodiments, range from about 0.01 milligrams/milliliter (mg/mL) to about 1 mg/mL, such as from about 0.02 mg/mL to about 0.5 mg/mL, such as from about 0.05 mg/mL to about 0.1 mg/mL, which equates to the GO being present in an amount ranging from about 0.001 wt. % to about 0.1 wt. %, such as from about 0.002 wt. % to about 0.05 wt. %, such as from about 0.005 wt. % to about 0.01 wt. %, based on the total weight of the coating solution. Meanwhile, amines, such as ethylenediamine (EDA), piperazine (PZ), monoethanolamine (MEA) or a combination thereof, can be incorporated into the GO coating solution in amounts ranging from about 0.1 wt. % to about 10 wt. %, such as from about 1 wt. % to about 7.5 wt. %, such as from about 2 wt. % to about 5 wt. %, of the total weight of the GO coating solution. Further, the temperature at which coating occurs can be above remove temperature and can range from about 30° C. to about 90° C., such as from about 45° C. to about 85° C., such as from about 60° C. to about 80° C. Further, the relative humidity in the environment during coating can range from about 84% to about 96%, such as from about 86% to about 94%, such as from about 88% to about 92%.

III. Method of Separating CO₂ from Flue Gas

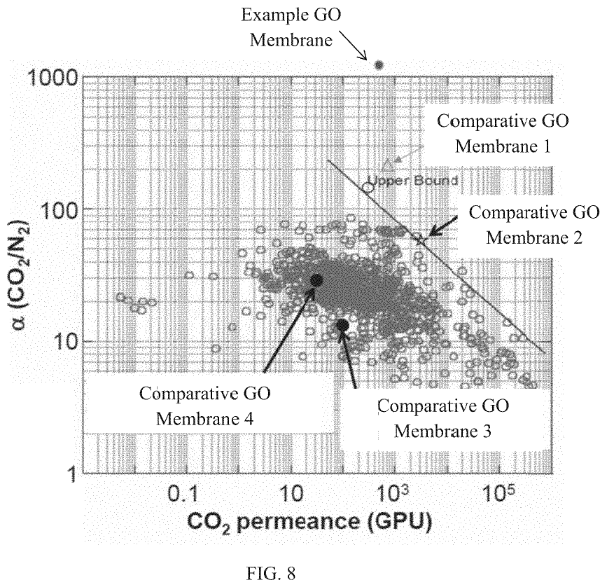

Referring now to FIG. 7, a method of selective separation of CO₂ from a feed of humidified flue gas is shown. In particular, when a mixture of CO₂, N₂, and H₂O molecules are fed to the surface of the GO coating 128, H₂O, which is the smallest molecule, is preferentially transported through the defects of the first flake or quantum dot of the GO coating 128. The affinity between the water molecules and GO flakes or quantum dots is high, and, as a result, the adsorbed water between the GO flakes or quantum dots swells the GO coating and increases the interlayer spacing from about 0.7 nm to about 1.1 nm. The adsorbed/condensed water between the GO flakes or dots in the coating 128 shows unimpeded permeation due to the low friction flow of water through the two-dimensional channels formed by closed paced GO sheets (flakes or dots) in the coating 128. Therefore, assuming a continuous water phase forms between the GO sheets, the ultrathin layered GO sheets in the coating 128 are expected to provide both high CO₂ permeance and high CO₂/N₂ selectivity, resulting from the much higher CO₂ solubility in water compared to N₂ (solubility ratio of 82 at 25° C. and 1 bar) and accelerated water transfer between the flakes/dots/sheets in the GO coating, which accelerates CO₂ permeation. Further, the addition of molecules with strong CO₂ affinity, such as amines, can be incorporated into the GO coating or grafted onto its surface to increase the amount of CO₂ absorbed in the membrane. Typically, most gas molecules, such as H₂, N₂, O₂, CO₂, and CH₄, can pass through the intrinsic nanochannels between the GO flakes or dots with low permeation resistance in dry feed conditions. Under wet conditions, all the gas permeances decrease due to the transport resistance generated from the adsorbed water molecules between the GO flakes or dots; adsorbed water molecules significantly hinder the gas permeation through GO membranes. Yet, gases have different solubility and diffusivity in water. At room temperature, gas solubility coefficients in water follow the sequence of CO₂>O₂>CH₄>N₂>H₂, and gas diffusion coefficients in water follow the reversed order of H₂>N₂>CH₄>O₂>CO₂. Contribution of solubility to gas permeance is greater than that of the diffusion coefficient, and CO₂ permeates through the GO membrane faster than other gases based on the solution-diffusion mechanism. Therefore, the presence of water in GO membranes can result in higher CO₂ permeance than that of other gases, and increase the selectivity of CO₂ over other gases.

The present invention may be better understood with reference to the following examples.

### Example 1

In the following example, CO₂ separation performance was determined for six different membrane configurations, which included PES hollow fiber substrates without a coating (sample 1), or with GO coatings (samples 2-6) that were coated onto the PES hollow fiber substrate under the conditions set forth below in Table 1.

TABLE 1
Representative membranes for 15% CO₂/85% N₂
mixture separation under wet condition.

| | | GO | Coating | | | |
|---|---|---|---|---|---|---|
| | | concen- | thick- | | CO₂ | |
| | | tration | ness, | Temp. | permeance | CO₂/N₂ |
| No. | Membrane | (mg/ml) | nm | ° C. | (GPU) | selectivity |
| 1 | PES HF support | | — | 24 | 5560 | — |
| 2 | GO 0 ml/min | 0.1 | 10-15 | 24 | 9 | 57 |
| | 0.5 min * | | | | | |
| 3 | GO + EDA | 0.05 | N/A | 60 | 69 | 463 |
| | (5%)† | | | | | |
| 4 | GO + PZ (5%)† | 0.1 | N/A | 80 | 117 | 298 |
| 5 | Modified | 0.1 | — | 80 | 291 | 727 |
| | GO + EDA^{#} | | | | | |
| 6 | GOQD + EDA^{#} | 0.1 | 30~40 | 80 | 350-520 | 500-1547 |

Note:
All of the samples used 20 min for vacuum drying.
Percentages of additives are based on weight.
* Samples of only GO (flow rate)(coating time).
†Samp1es of GO + additives (PZ, EDA and MEA) were coated at 0 ml/min flow rate and 0.5 min coating time.
^{#}Humidity is 90%.

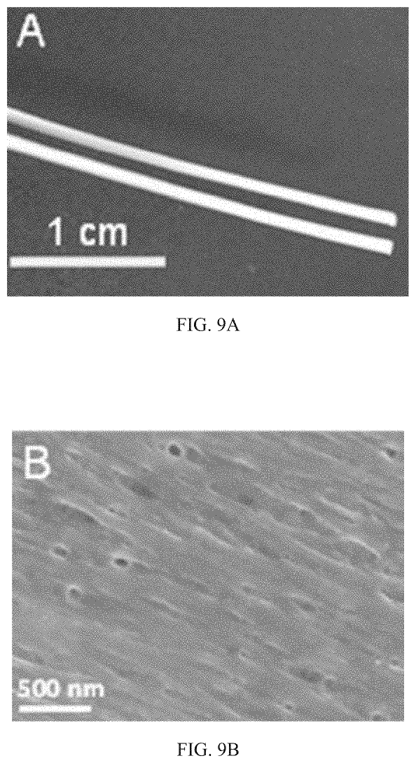

As shown above in Table 1, the PES substrate has a high CO₂ permeance of 5,560 GPU such that it is expected to have a negligible effect on CO₂ permeation. The substrates coated with GO without any amines incorporated into the coating solution showed relatively low CO₂ permeance (less than 10 GPU), due at least in part to the low solubility of CO₂ in water. Adding amines (EDA, PZ) and/or modifying the GO to add more functional groups or more structural defects, or using GOOD significantly increased the CO₂ permeance and selectivity for CO₂ over N₂. For instance, the PES hollow fiber substrate coated with a coating containing GOOD and EDA exhibited a CO₂ permeance as high as 520 GPU and a CO₂/N₂ selectivity a as high as 1547. Next, the membrane in sample 6 was compared with four known membranes where comparative GO membrane 1 was a zeolite/polymer composite membrane, comparative GO membrane 2 was a polymeric, spiral wound gas separation membrane, comparative GO membrane 3 was a mixed matrix type membrane, and comparative GO membrane 4 was a composite hollow fiber membrane. As shown in FIG. 8, the GO-coated hollow fiber substrate of the present invention exhibited improved CO₂ selectivity over the comparative membrane while at the same time exhibiting a high CO₂ permeance.

### Example 2

In the following example, a variation of the solution-based deposition method established for making flat sheet GO membranes was used in preparing GO membranes on hollow fibers. As shown in FIG. 2B, a PES hollow fiber was inserted into a GO dispersion with desired concentration, and then vacuum was applied on the other side of the hollow fiber to pull the GO dispersion into the lumen. After being filled with GO dispersion, the fiber was removed from the GO dispersion, while maintaining vacuum on the other side. When the GO dispersion in the hollow fiber was removed, air flowed into the lumen and dried the inner surface to form a thin GO coating.

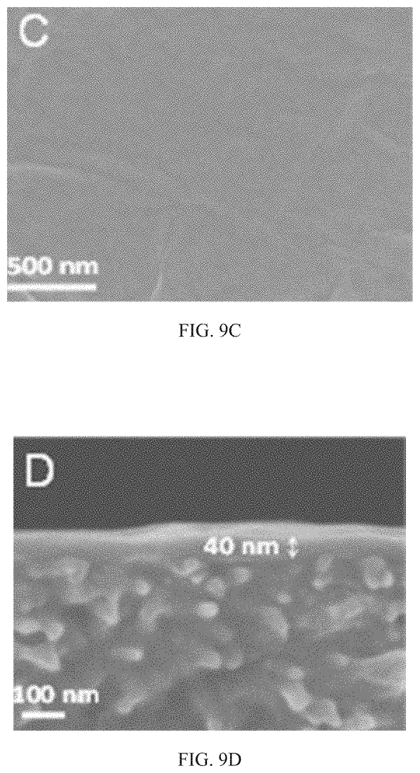

The blank PES support (FIG. 9A) has about 100 nm pores sparsely distributed on the surface (FIG. 9B). After GO coating, the support pores have been covered and a smooth coating can be seen (FIG. 9C). The cross-sectional view (FIG. 9D) shows the GO coating layer was approximately 40 nm thick. Note that a 0.5 mg/ml GO dispersion was used as the coating solution. When the GO dispersion concentration was increased or decreased, the GO coating thickness increased or decreased correspondingly. A GO membrane was tested for CO₂/N₂ separation and obtained a selectivity of 50 at 40° C. for a humidified 15%/85% CO₂/N₂ mixture when using argon as sweep gas on the permeate side. The CO₂ permeance was 100 GPU. Similar performance was reported very recently by Kim et al. for their GO membranes.

A GO coating was also deposited on a flat PES support by vacuum filtration and obtained similar CO₂/N₂ separation result. Incorporating amines (ethylenediamine, piperazine, etc.) is expected to drastically increase CO₂ permeance and CO₂ selectivity over other inert molecules (N₂, CH₄, etc.) due to the enhanced CO₂ solubility and facilitated transport.

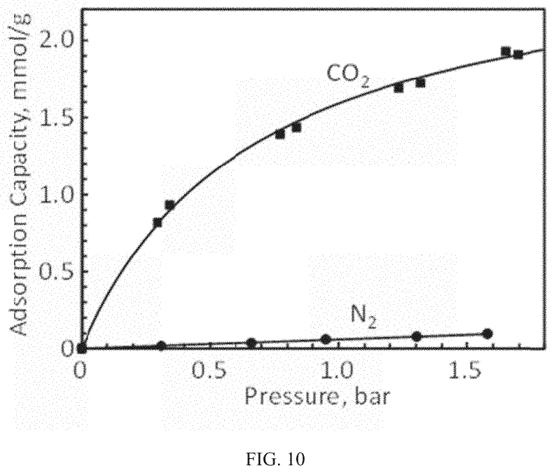

Referring to FIG. 10, adsorption isotherms showed that CO₂ is adsorbed more strongly than N₂ on GO at 25° C. The ideal CO₂/N₂ adsorption selectivity is 27 at a pressure of 1 bar and increases to 52 at 0.3 bar. Thus, the preferential adsorption of CO₂ over N₂ would favor separating CO₂ over N₂. On the other hand, the smaller molecule CO₂ (kinetic diameter: 0.33 nm) diffuses faster than the larger molecule N₂ (0.364 nm), which also favors the separation of CO₂ over N₂. We also expect preferential CO₂ adsorption over other inert molecules, such as CH₄.

Table 2 shows the tensile modulus (1.7 GPa) and tensile strength (20.2 MPa) of free-standing GO film prepared by solution-casting method 5 are comparable to those of the common membrane materials, indicating good mechanical stability of the GO membranes.

TABLE 2
Thermo-mechanical properties of membrane materials

| | Tensile | Tensile | Max service |
|---|---|---|---|
| | modulus, | strength, | temperature, |
| Material | GPa | MPa | ° C. |
| Teflon ™ | 0.4-0.5 | 17-21 | 250 |
| PVDF | 0.8 | 48 | 150 |
| Polysulfone | 2.6 | 70 | 160 |
| GO film (solution-casted) | 1.7 | 20.2 | 150 |
| PEEK | 4 | 97 | 271 |

GO is typically prepared under strong acid and oxidation conditions in aqueous solution, and thus is expected to be very stable under these harsh conditions. Additionally, they are hydrothermally stable at 150° C. and have good chemical stability and are mechanically strong. Therefore, GO is expected to be stable under flue gas conditions and with flue gas contaminants, such as NO₂, SOₓ, etc.

GO, therefore, is an ideal membrane material for making the thinnest membranes for high permeance, high selectivity CO₂ separation applications. In our preliminary results, a 40-nm thick GO membrane was deposited. By controlling deposition condition, it is expected that thinner GO membranes may be deposited to promote CO₂ permeance. By adding amines to GO membranes, it is expected to further increase CO₂ permeance and simultaneously increase CO₂ selectivity over other components.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

1. A membrane for the capture of carbon dioxide, the membrane comprising:
a polymeric porous hollow fiber substrate; and
a coating disposed on a surface of the polymeric porous hollow fiber substrate, wherein the coating comprises graphene oxide and an amine.

2. The membrane as defined in claim 1, wherein the polymeric porous hollow fiber substrate comprises polyethersulfone, polyetheretherketone, polyetherimide, or a combination thereof.

3. The membrane as defined in claim 1, wherein the polymeric porous hollow fiber substrate has a pore size ranging from about 1 nanometer to about 100 nanometers.

4. The membrane as defined in claim 1, wherein the coating has a thickness ranging from about 1 nanometer to about 100 nanometers.

5. The membrane as defined in claim 1, wherein the graphene oxide comprises graphene oxide quantum dots.

6. The membrane as defined in claim 1, wherein structural defects are present on the coating.

7. The membrane as in claim 1, wherein the amine comprises ethylenediamine, piperazine, monoethanolamine, or a combination thereof.

8. The membrane as defined in claim 1, wherein the membrane has a carbon dioxide/nitrogen selectivity ranging from about 200 to about 2000.

9. The membrane as in claim 1, wherein the membrane has a carbon dioxide permeance ranging from about 100 gas permeation units to about 1000 gas permeation units.

10. A method of removing carbon dioxide from a mixture of gas, the method comprising:
exposing the membrane as defined in claim 1 to the mixture of gas.

11. A method of forming a coated polymeric hollow fiber support for the capture of carbon dioxide, the method comprising:
dispersing graphene oxide in a coating solution comprising a solvent;
dispersing an amine in the coating solution; and
exposing a polymeric hollow fiber support to the coating solution to form a coating on a surface of the polymeric hollow fiber support, wherein the coated polymeric hollow fiber support has a carbon dioxide/nitrogen selectivity ranging from about 200 to about 2000 and a carbon dioxide permeance ranging from about 100 gas permeation units to about 1000 gas permeation units.

12. The method of claim 11, wherein the solvent is water.

13. The method of claim 11, wherein the polymeric hollow fiber substrate comprises polyethersulfone, polyetheretherketone, polyetherimide, or a combination thereof.

14. The method of claim 11, wherein the graphene oxide comprises graphene oxide quantum dots.

15. The method of claim 11, wherein the graphene oxide is present in the coating solution at a concentration ranging from about 0.001 wt. % to about 1 wt. % based on the total weight of the coating solution.

16. The method of claim 11, wherein the amine comprises ethylenediamine, piperazine, monoethanolamine, or a combination thereof.

17. The method of claim 11, wherein the amine is present in the coating solution at a concentration ranging from about 0.1 wt. % to about 10 wt. % based on the total weight of the coating solution.

18. The method of claim 11, wherein polymeric porous hollow fiber substrate is exposed to the coating solution under vacuum filtration for a time period ranging from about 10 seconds to about 5 minutes.

19. The method of claim 11, further comprising forming structural defects in the coating.

20. The method of claim 11, further comprising subjecting the membrane to vacuum drying for a time period ranging from about 1 minute to about 1 hour.

21-23. (canceled)
